(19) United States
(12) Patent Application Publication
(10) Pub. No.: US 2009/0296741 A1
(43) Pub. Date: Dec. 3, 2009

(54) VIDEO PROCESSOR AND VIDEO PROCESSING METHOD

(76) Inventors: Yoshihisa KIZUKA, Ome-shi (JP); Hitoshi SAIJO, Kunitachi-shi (JP); Sayoko TANAKA, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/474,352

(22) Filed: May 29, 2009

(30) Foreign Application Priority Data
May 30, 2008 (JP) 2008-143507

(51) Int. Cl. H04H 20/28; H04N 11/04

(52) U.S. Cl. 370/487; 375/240.01; 386/E05.001

(57) ABSTRACT

According to one embodiment, a video processor includes an interface module which sequentially receives two video and audio multiplex streams to be spliced as a preceding stream and a following stream, and a stream converting module which sequentially extracts time information monotonously increasing in each of the preceding stream and the following stream received by the interface module and performs rewriting for shifting one time information of either the preceding stream or the following stream in lump such that the time information is continuous at a splice point between the preceding stream and the following stream.

### CROSS-REFERENCE TO RELATED APPLICATIONS

This application is based upon and claims the benefit of priority from Japanese Patent Application No. 2008-143507, filed May 30, 2008, the entire contents of which are incorporated herein by reference.

### BACKGROUND

1. Field

An embodiment of the invention relates to a video processor and a video processing method for seamlessly splicing two video and audio multiplex streams.

2. Description of the Related Art

Recently, in the case of storing or transmitting a large amount of video information and audio information in digital fashion, the information has been generally coded in the MPEG (Moving Picture Experts Group) method. The MPEG method is an encoding method of the international standard known as the ISO/IEC 11172 Standard or the ISO/IEC 13818 Standard, and it is used, for example, to encode video information and audio information in digital satellite broadcasting, a DVD recorder, and a digital video camera. In the ISO/IEC 13818 Standard (namely, the MPEG-2 Standard), video information and audio information are converted into a video stream including a series of encoded video data and an audio stream including a series of encoded audio data, respectively. The video data is the data encoded for every picture and edited in every group of picture (GOP) including pictures each of which is a unit of motion compensation estimation. The audio data is encoded in every audio frame. The video stream and the audio stream are formed into packets independently and multiplexed, for example, as Transport Stream. The obtained video and audio multiplex stream is edited in every unit (VOBU) of continuous packets from a packet including a head of some GOP to a packet including the head of the next GOP.

When the video and audio multiplex stream is edited after dividing each into a preceding stream and the following stream in the VOBU boundary, there easily occurs such a gap as meaning a discontinuity of the time information between an end point of the preceding stream and a start point of the following stream after the edition. This gap makes it difficult to seamlessly splice the preceding and following streams in order to reproduce video and audio continuously and smoothly without stopping them.

In the conventional art, after a preceding stream and the following stream are decoded in order to perform the seamless splicing, it has been necessary to correct a time lag of the reproduction time and to encode the correction result again. Further, a method for coping with the gap by the correction using offset of time information has been proposed (for example, refer to Jpn. Pat. Appln. KOKAI Publication No. 2001-320704).

The technique in Jpn. Pat. Appln. KOKAI Publication No. 2001-320704, however, does not need the conventional re-encoded time, but it needs to provide hardware in a reproduction device for managing the time information in order to adjust the gap.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the schematic structure of a seamless reproducing system according to an embodiment of the invention;

FIG. 2 is an exemplary block diagram showing the structure of a video processor shown in FIG. 1;

FIG. 3 is an exemplary diagram showing the processing performed by a stream converting module shown in FIG. 2;

FIG. 4 is an exemplary diagram showing a change in the time information obtained by the stream conversion shown in FIG. 3;

FIG. 5 is an exemplary diagram showing the data structure of PES that is an object of separation and PTS/DTS rewriting processing shown in FIG. 3; and

FIG. 6 is an exemplary diagram showing the bit structure of PTS and DTS shown in FIG. 5.

### DETAILED DESCRIPTION

Various embodiments according to the invention will be described hereinafter with reference to the accompanying drawings.

According to one embodiment of the invention, there is provided a video processor comprising: an interface module configured to sequentially receive two video and audio multiplex streams to be spliced as a preceding stream and a following stream; and a stream converting module configured to sequentially extract time information monotonously increasing in each of the preceding stream and the following stream received by the interface module and perform rewriting for shifting one time information of either the preceding stream or the following stream in lump such that the time information is continuous at a splice point between the preceding stream and the following stream.

According to one embodiment of the invention, there is provided a video processing method comprising: sequentially receiving two video and audio multiplex streams to be spliced as a preceding stream and a following stream; sequentially extracting time information monotonously increasing in each of the preceding stream and the following stream; and performing rewriting for shifting one time information of either the preceding stream or the following stream in lump such that the time information is continuous at a splice point between the preceding stream and the following stream.

In the video processor and video processing method, the time information increasing monotonously in each of the preceding stream and the following stream is extracted in sequence, and rewriting is performed for shifting the time information of either the preceding stream or the following stream in the lump such that the time information may be continuous at a splice point between the preceding stream and the following stream. Therefore, it is possible to seamlessly splice the preceding stream and the following stream without changing the hardware structure of the reproducing device.

Hereinafter, a seamless reproducing system according to an embodiment of the invention will be described. The seamless reproducing system is used for reproducing two preceding and following streams in seamless splice which are sequentially output as divided edition result, for example, from a digital video camera which encodes the video and audio information in the MPEG method and stores them as a video and audio multiplex stream (program stream).

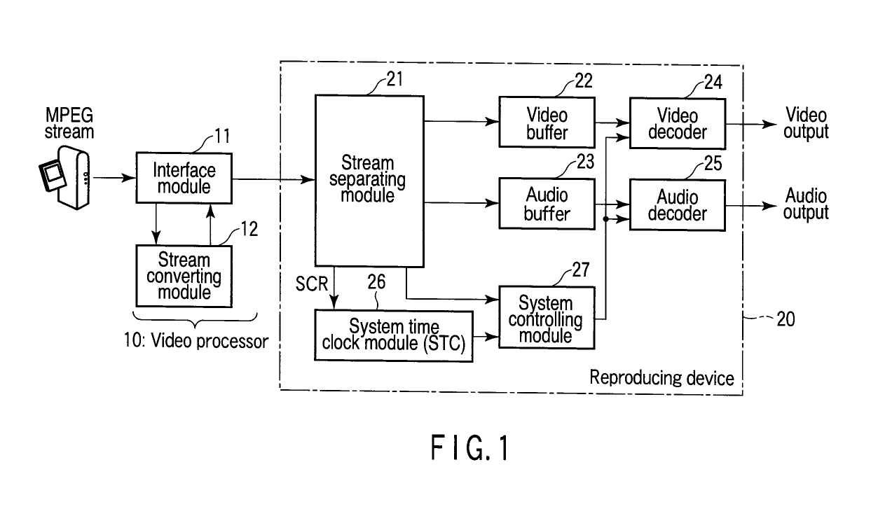

FIG. 1 shows the schematic structure of the seamless reproducing system. The seamless reproducing system comprises a video processor 10 which seamlessly splices a preceding stream and the following stream, and a reproducing device 20 which reproduces the stream provided from the video processor 10 as the result of the seamless splicing.

The video processor 10 includes an interface module 11 which sequentially receives two video and audio multiplex streams (program stream) to be spliced as the preceding stream and the following stream and a stream converting module 12 which sequentially extracts the time information increasing monotonously in each of the preceding stream and the following stream received by the interface module 11 and performs rewriting for shifting the time information of either the preceding stream or the following stream in the lump such that the time information may be continuous at a splice point between the preceding stream and the following stream.

The reproducing device 20 includes a stream separating module 21, a video buffer 22, an audio buffer 23, a video decoder 24, an audio decoder 25, a system time clock module 26, and a system controlling module 27. The stream separating module 21 receives the stream provided from the video processor 10, divides it into a video packet and an audio packet, transmits the video packet to the video buffer 22, and transmits the audio packet to the audio buffer 23. While accumulating the video packets, the video buffer 22 transmits them to the video decoder 24, and while accumulating the audio packets, the audio buffer 23 transmits them to the audio decoder 25. The system time clock module 26 generates a system time (STC: System Time Clock) that becomes a reference of decoding and reproducing timing of the video packet and the audio packet, for synchronization between the video and the audio.

The video decoder 24 compares a time stamp described in the received video packet with the system time, decodes and reproduces the video at a timing corresponding to the time stamp. The audio decoder 25 compares a time stamp described in the received audio packet with the system time, decodes and reproduces the audio at a timing corresponding to the time stamp.

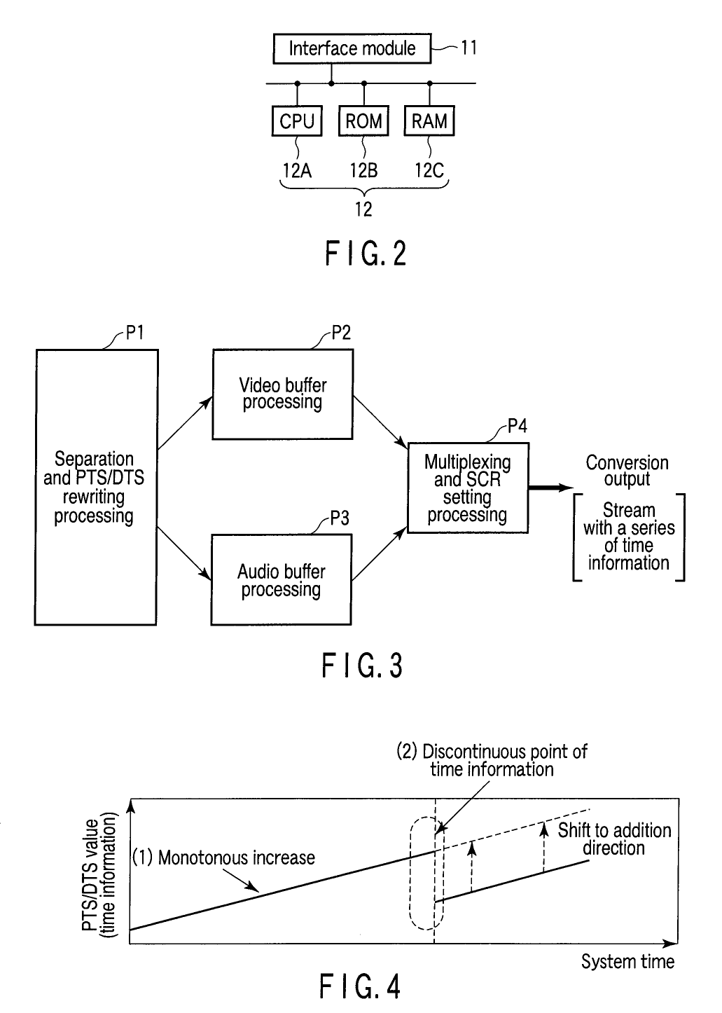

FIG. 2 shows a structure example of the video processor 10. Here, a CPU 12A, a ROM 12B, and a RAM 12C serve as the stream converting module 12 and are connected to the interface module 11 through a bus line. The CPU 12A is to perform various processing on the stream. The ROM 12B holds a control program and initial data of the CPU 12A as application software. The RAM 12C temporarily stores data input to and output from the CPU 12A.

In the MPEG method, the decode time and the display time are controlled by using PTS (Presentation Time Stamp) showing the display time for every picture and DTS (Decode Time Stamp) showing the transmission time (decode time) from the buffer to the decoder in the reproducing device 20, based on the STC (System Time Clock) that is the reference time information of the stream data. In this embodiment, of two kinds of MPEG methods, a program stream type is assumed and it is the same also in a transport stream type. In the case of the program stream, the STC is created based on the SCR (System Clock Reference) in the stream. The SCR is a reference time at the time of encoding the stream and described in a pack header of the program stream at the accuracy of 27 MHz. In the reproducing system, when the STC comes to the time of the DTS, the picture is decoded and when it comes to the time of the PTS, the picture is displayed. The stream separating module shown in FIG. 1 is a functional module which separates the multiplexed audio data, video data, and the other data and transmits the time information to a system time management module (STC).

Since one video data has a series of time information, the reproducing device 20 generally operates without any problems, but there is the case where the time information is discontinuous due to some condition of an encoder. For example, a video taken by a digital video camera is apt to be discontinuous in the time information at record start and pause points. In this case, the reproducing device 20 cannot cope with the discontinuity, resulting in a stop of the reproduction and disturbance of the video.

Therefore, in order to resolve the discontinuous portion, in the embodiment, the stream converting module 12 performs the stream converting processing for rewriting the time information, as shown in FIG. 3. Since the PTS/DTS are counters of 90 KHz of 32 bit, the counter comes full circle (wraparound) in about 13 hours even when starting from the minimum value. In such a situation, since the time information changes from about the maximum value to the minimum value abruptly in the reproducing device 20, data cannot be reproduced smoothly in many cases. Since the counter is not always used from the minimum value, this phenomenon occurs not only in a content of more than 13 hours.

Then, the stream converting module 12 makes the whole time information to have the minimum value at the head of the stream as a countermeasure against the wraparound in the stream converting processing, hence to convert into smooth streams for the reproducing device 20.

The stream converting processing includes separation and PTS/DTS rewriting processing P1, video buffer processing P2, audio buffer processing P3, and multiplexing and SCR setting processing P4. In the separation and PTS/DTS rewriting processing P1, the separation of the video packet and the audio packet, and offset (rewrite) of the DTS and PTS are performed. In the rewriting, addition or subtraction of the shift amount is performed on the time information of either the PTS or the DTS in order not to cause a wraparound in the range of the bit number of the PTS and DTS. The video packet and the audio packet are temporarily stored as the video buffer processing P2 and the audio buffer processing P3 respectively. Thereafter, in order to output the program stream, the multiplexing and SCR setting processing P4 is performed. Here, the value according to the rewritten time information is substituted for the SCR.

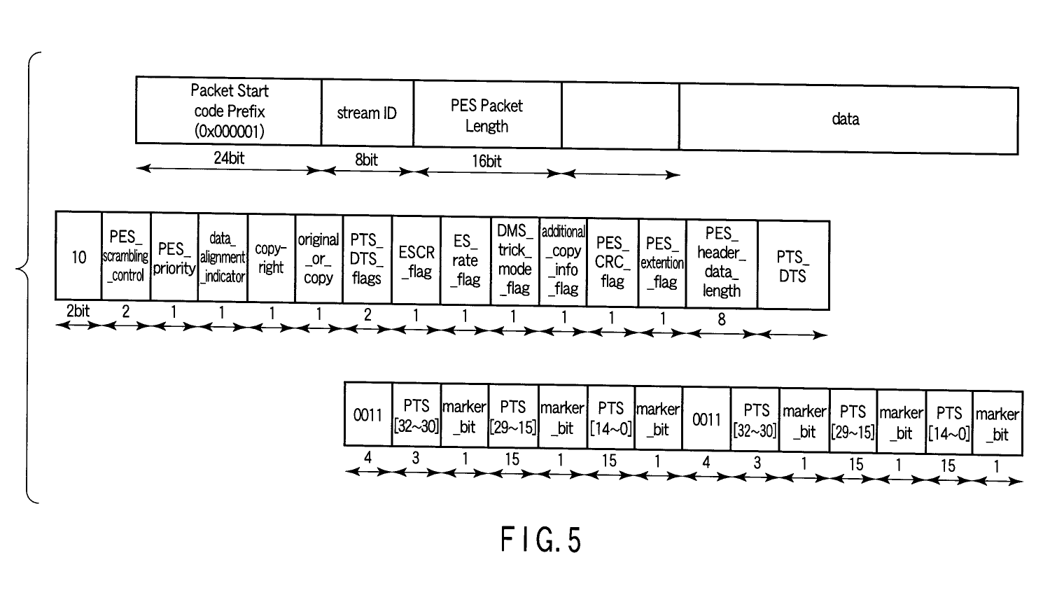

FIG. 4 shows a change in the time information obtained by the above mentioned stream converting processing. By the rewriting for shifting the PTS/DTS (time information) toward a direction of addition, it is continuous also at a splice point of the preceding stream and the following stream.

FIG. 5 shows the data structure of PES (Packetized Elementary Stream) that is an object of the separation and PTS/DTS rewriting processing P1.

The DTS (PTS) is set within the PES packet of the MPEG Standard and the data structure of the PES format is as shown in FIG. 5. Whether there exists a value or not can be checked according to the setting flag of each item. FIG. 5 shows an example with the PTS and the DTS set there.

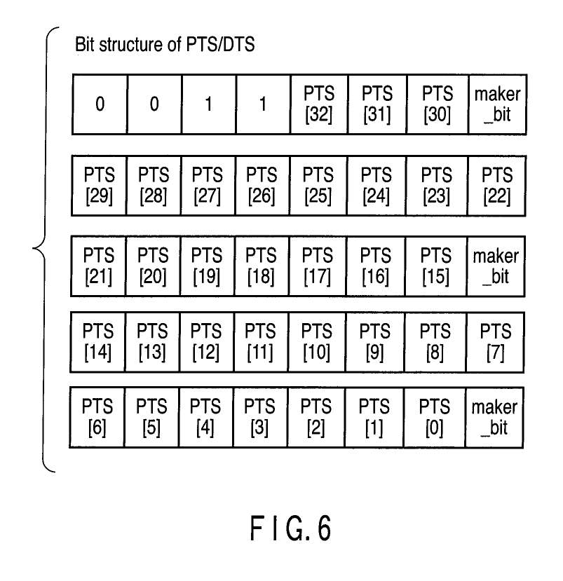

FIG. 6 shows the bit structure of the PTS/DTS. The rewriting of the time information in the embodiment uses only upper PTS [32] to PTS [22]. In other words, the stream converting module 12 performs the addition or subtraction of the shift amount on predetermined upper bits of the time information. Since it counts only about 45 seconds in the lower PTS [0] to PTS [21], there is no large influence, and only the upper PTS/DTS has to be taken into consideration, to make the following 32-bit calculation easier.

The stream converting processing is started and when the DTS [32] to [22] of the PES obtained at first are all zero, rewriting is not necessary and it is not performed. On the other hand, the stream converting processing is started and when the DTS [32] to PTS [22] of the PES obtained at first are other than zero, the upper DTS [32] to [22] are rewritten to “0x001” absolutely. After the processing is started based on the first obtained DTS, the display time of one picture, 3003 is added to the DTS for every picture as for the NTSC system, and in the case of storing a new PTS together with the DTS, a difference value between the original PTS and the DTS may be added to the DTS stored together. In the case of storing only the PTS, since the PTS is regarded the same as the DTS, the latest DTS+3003 becomes the PTS.

In summary, rewriting is performed as follows.

(Setting of Initial DTS)

When the DTS [32] to [22] are zero, nothing special is performed.

When the DTS [32] to [22] are other than zero, the upper DTS [32] to [22] are set at 0x001.

(Setting of DTS)

new DTS=the number of pictures×3003+initial DTS

(PTS Setting of PES Including Both DTS/PTS)

new PTS=old PTS−old DTS+new DTS

(PTS Setting of PES Including Only PTS)

new PTS=latest set DTS+(3003×the number of pictures from the picture with DTS set to the latest picture)

According to this processing, it is possible to convert the streams into the stream free from discontinuity of the time information for the period of about 13 hours. The stream converting module 12 further performs the rewriting for filling a gap of the time information existing in each stream. Namely, since the stream converting module 12 forcedly substitutes a continuous value for the time information, it is possible to fill a gap not only at a time of wraparound but also when there exists the gap of the time information in the original stream.

Although FIG. 4 shows a theoretical example, the actual PTS does not always show a monotonous increase because of a reference frame of the MPEG, with some fluctuation in the GOP (Group of Pictures). Paying attention, for example, only to the I-Picture, however, it shows a monotonous increase.

In the above-mentioned embodiment, the time information monotonously increasing respectively in the preceding stream and the following stream is sequentially extracted and the rewriting is performed for shifting the time information of either the preceding stream or the following stream in the lump such that the time information may be continuous at a splice point between the preceding stream and the following stream. Therefore, it is possible to seamlessly splice the preceding stream and the following stream without changing the hardware structure of the reproducing device 20.

Specifically, by resolving the discontinuous portion of the time information of the video and audio stream data encoded in the MPEG system, the reproducing device 20 can reproduce the data smoothly. It works effectively, especially in the ordinary network reproduction and in the case of reproduction when the stream information about the discontinuous point of the time information cannot be previously input to the reproducing device. When a wraparound of the time information occurs in the encoded stream, its occurrence can be restrained during the reproducing time of about 13 hours. When the time information is discontinuous on the way of the stream due to some condition of the encoder, it is possible to make that portion continuous.

In the embodiment, since the stream converting module 12 is formed by software base, it has general versatility; for example, it can perform the conversion between the Blu-ray formats and the steam conversion including the conversion from the Blu-ray format to the DVD format.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processor comprising:
an interface module configured to sequentially receive two video and audio multiplex streams to be spliced as a preceding stream and a following stream; and
a stream converting module configured to sequentially extract time information monotonously increasing in each of the preceding stream and the following stream received by the interface module and performs rewriting for shifting one time information of either the preceding stream or the following stream in lump such that the time information is continuous at a splice point between the preceding stream and the following stream.

2. The video processor of claim 1, wherein the video and audio multiplex stream is a stream of MPEG (Moving Picture Experts Group) format, and
the stream converting module is configured to deal with a PTS (Presentation Time Stamp) and a DTS (Decode Time Stamp) of each stream as the time information.

3. The video processor of claim 2, wherein the stream converting module is configured to perform addition or subtraction of a shift amount on the one time information in order not to generate a wraparound in a range of bit number of the PTS and the DTS.

4. The video processor of claim 3, wherein the stream converting module is configured to perform the addition or subtraction of the shift amount on predetermined upper bits of the time information.

5. The video processor of claim 1, wherein the stream converting module is configured to further perform rewriting for filling a gap of the time information in each stream.

6. A video processing method comprising:
sequentially receiving two video and audio multiplex streams to be spliced as a preceding stream and a following stream;
sequentially extracting time information monotonously increasing in each of the preceding stream and the following stream; and
performing rewriting for shifting one time information of either the preceding stream or the following stream in lump such that the time information is continuous at a splice point between the preceding stream and the following stream.

7. The video processing method of claim 6, wherein the video and audio multiplex stream is a stream of MPEG (Moving Picture Experts Group) format, and a PTS (Presentation Time Stamp) and a DTS (Decode Time Stamp) of each stream are dealt with as the time information.

8. The video processing method of claim 7, further comprising:
performing addition or subtraction of a shift amount on the one time information in order not to generate a wraparound in a range of bit number of the PTS and the DTS.

9. The video processing method of claim 8, further comprising:
performing the addition or subtraction of the shift amount on predetermined upper bits of the time information.

10. The video processing method of claim 6, further comprising:
performing rewriting for filling a gap of the time information in each stream.
